(19) United States
(12) Patent Application Publication
(10) Pub. No.: US 2005/0236462 A1
(43) Pub. Date: Oct. 27, 2005

(54) Brazing method for brass parts using copper solder

(76) Inventors: Kiichi Kanda, Hiratsuka-shi (JP); Masashi Fuse, Kariya-city (JP); Hiroki Tarui, Kariya-city (JP); Sadamu Shiotsuki, Kariya-city (JP)

Correspondence Address: SHLESINGER, ARKWRIGHT & GARVEY LLP, Suite 600, 1420 King Street, Alexandria, VA, 22314, US

(21) Appl. No.: 11/100,560

(22) Filed: Apr. 7, 2005

(30) Foreign Application Priority Data
Apr. 26, 2004 (JP) 2004-129185

(51) Int. Cl. B23K 31/02

(52) U.S. Cl. 228/220; 228/245

(57) ABSTRACT

A method of brazing brass parts without oxidation of zinc, which is contained in the parts, during brazing of the parts with phosphorous bronze solder at relatively low temperature of 630-700° C., the brazing being made by making the wall of brazing furnace or muffle of carbon material, like graphite etc., making an inert nitrogen gas or mixture of nitrogen and hydrogen in the furnace atmosphere contact with the carbon material above, producing CO less the P co=10⁻³ atm. in the furnace, and making the furnace atmosphere reductive against zinc in the brass parts and/or flux in the solder.

### BACKGROUND OF THE INVENTION

This invention relates to a brazing method for brass parts using copper solder. More particularly this invention relates to a brazing method for brass parts containing zinc using a phosphorous bronze solder whose melting point is relatively low temperature of 630-700° C.

The patent and non-patent documents below are relating to the background technologies in the field of this invention.

Patent document 1: Japanese Patent Published Number Heisei 8-277448 “A method of heat treatment of metal containing zinc in a continuous furnace.”

Non-patent document 1: Technical data sheet “Cubond CB” of North American Hogans in 2003.

In the patent document 1, a example is indicated to braze in a continuous tunnel type furnace with wall made of carbon material in a nitrogen atmosphere. A silver type solder (JIS-Bag-7) is used and a method to prevent the evaporation of zinc from brass parts and the effect of this method are discussed.

In the non-patent document 1, the solder to braze brass parts of heat exchangers for automobile and other industrial use is discussed. In this document particularly a phosphorous bronze solder (one of the composition example is, Sn: 9.4-15.6%, Ni: 4.2-7.2%, P: 5.3-6.6%, Cu: the balance) is introduced. This type solder has relatively low melting point and brazing is performed under the temperature of 630-700° C.

The necessity of using a controlled atmosphere in a continuous or a batch furnace in brazing brass parts is discussed in the non-patent document 1 above. And nitrogen or nitrogen including 5-8% of hydrogen is recommended as a furnace atmosphere. Also oxygen content below 20 ppm and dew point below 34° C. are recommended as a furnace atmospheric condition.

Brass parts used for heat exchangers mentioned above are generally made of Cu—Zn type alloy whose melting point is between 820 and 980° C. in order to meet the required mechanical properties such as stretch and extension strength and hardness. One example of this kind of brass is SM 2385 (IS C66420, product number of Autokump of Sweden), α phase Cu—Zn type alloy including zinc up to 35%.

### BRIEF SUMMARY OF THE INVENTION

Since parts to be brazed in this invention is brass including zinc as mentioned above, oxidation of zinc during brazing must be avoided as much as possible. A solder used in this brazing is phosphorous bronze and brazing temperature is, again as mentioned above, relatively low of 630-670° C. In other words, avoidance of oxidation of zinc in brass parts during such low temperature brazing is the issue to be solved in this invention.

However it is inevitable to bring the air outside into a furnace together with parts to be brazed and it prevents to keep an atmosphere of the furnace neutral or under low partial pressure of oxygen.

As mentioned above the non-patent document 1 shows addition of hydrogen to a inert gas nitrogen atmosphere in a furnace keeps the atmosphere reductive and prevents this kind of phenomenon. However under low brazing temperature range of 630-760° C. as in this invention, addition of a few percent of hydrogen can not reduce zinc because negative value of oxide standard formation free energy (ΔGo) of the atmosphere is smaller than that of zinc. In other words even if high level of hydrogen such as neighborhood of explosion limit is introduced to the nitrogen atmosphere, which does not have CO, hydrogen can not be reductive against zinc without CO.

In this invention a tunnel type continuous atmospheric furnace is employed for the brazing, this furnace has carbon material wall or muffle, and CO content in nitrogen or nitrogen hydrogen mixture gas in the furnace atmosphere is kept between P co=10⁻⁶ atm. and P co=10⁻⁴ atm. by the reaction between oxygen introduced from the air outside and carbon of furnace wall or muffle. Consequently zinc in brass parts is not oxidized by oxygen during the brazing so that brazing property of the parts is not deteriorated and also anti-corrosion property of the parts is not reduced.

Nothing is mentioned either in the patent document 1 or in the non-patent document 1 above regarding this kind of new solving method in this invention. If necessary hydrogen can be added up to 10 volume percent as far as explosion danger does not exist or it is not dangerous.

A solder used in this invention is preferably phosphorous bronze and P is involved to work as oxygen avoiding agent so that tin in this solder does not hinder the brazing by being oxidized during melting.

By this invention good brazing has been achieved in brass parts using a phosphorous bronze solder. Furthermore no decrease has been seen in anti-corrosion property and mechanical property of brass parts such as strength and hardness because brazing temperature has been relatively low in this invention.

This invention can be utilized economically and in high reliability in the application of brazing of brass core parts of heat exchangers for automobile and other industrial use by a phosphorous bronze solder like non-patent document 1. Particularly this invention in the form of example 1 can be satisfactorily used for copper brazing between copper fin and brass tube, and the form of example 2 can be satisfactorily used for copper brazing between the tube mentioned above and brass header tank respectively.

### BRIEF DESCRIPTION OF DRAWING

FIG. 1 indicates the heating temperature pattern employed in example 1 and example 2 below.

### EXAMPLES

### Example 1

A tunnel type continuous furnace whose inner wall was made of graphite was used. Nitrogen was used as an atmosphere.

Two pieces of brass (ISC66420)=Product number of Autokump of Sweden, Cu 84.0-86.0%: Zn the balance: Fe 0.7-0.9%: P max 0.03%: Mn max 0.05%: Ni max 0.10%: Sn max 0.10%: Al max 0.03%: Ag max 0.10%: Pb max 0.05%) were laid up in reverse T shape, composed and connection part was brazed by a copper solder. The copper solder used here was Cobrabond SPT 600 (Product name of phosphorous bronze solder of North American Hoganas and mixture of phosphorous bronze powder consist of Sn 15.6%: Ni 4.2%: P 5.3%: Cu the balance, and organic binder).

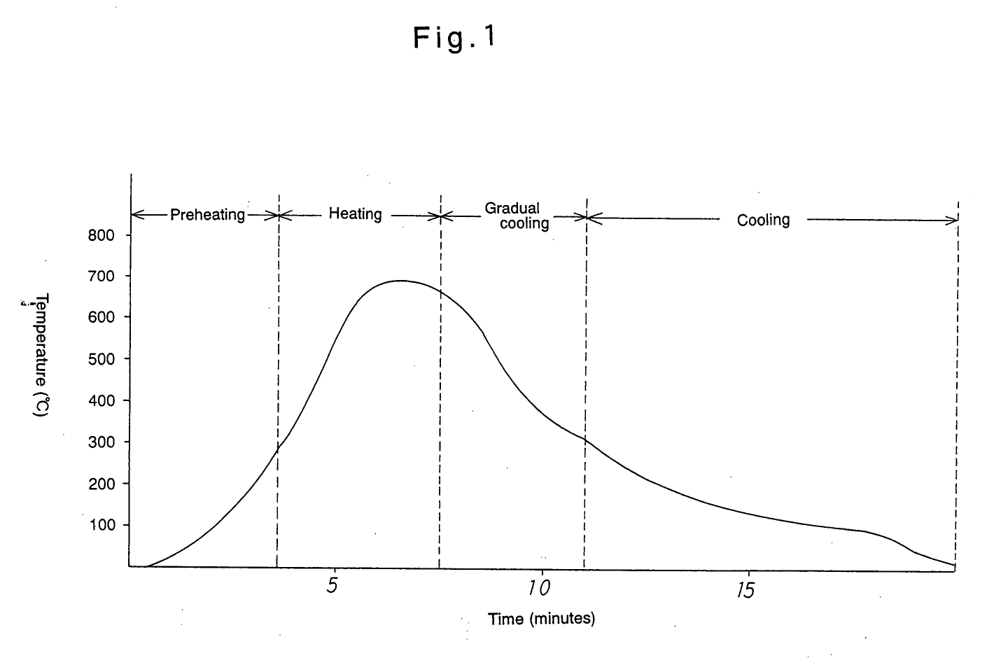

Composed parts above were sent to the continuous atmospheric furnace mentioned above, heated as the temperature profile shown in FIG. 1 and brazed at the temperature of 650-700° C. Beautiful brazing was obtained and no oxidation of zinc in the parts was observed. The nitrogen atmosphere in the furnace was maintained reductive by involving CO in the concentration of partial pressure between P co=10⁻³ atm. and 10⁻⁶ atm. Concentration of oxygen was below 6 ppm.

### Example 2

Same continuous atmospheric furnace used in example 1 was used. Since the zinc content of one of the parts was higher in this example, 10 volume percent of hydrogen was added into the nitrogen atmosphere. And CO in this atmospheric gas was partially hydrogenated to prevent both the oxidation of zinc in brass parts, which sometimes occurred during the heating stage up to brazing temperature, and the self-oxidation of flux of a metal solder mentioned later.

One of the two pieces laid up in reverse T shape and composed was SM 2385 brass mentioned above and the other piece was SM 2464=ISC4400 brass (Cu 63.0-64.5%: Zn the balance: Ni 2.5%: Fe max 0.10%: P max 0.03%: Mn max 0.05%: Sn max 0.10%: Al max 0.03%: Ag max 0.10%: Pb max 0.05%).

Connecting parts of two pieces were coated with Cubond CB PH621 (Product name of other phosphorous bronze solder of North American Hoganas, paste type, a mixture of metal solder Sn 9.4%: Ni 7.2%: P 6.6%: Cu the balance, and flux (KBF4)). Composed parts were sent to the furnace and brazed through the same heating profile as example 1. Good brazing was obtained like example 1. Although one of the two pieces had more zinc than that of example 1, no oxidized film was observed on the whole surface of composed parts. Self-oxidation of flux, which sometimes may occur, was not observed too.

1. A method of copper brazing of brass parts comprising:
a) making the wall of brazing furnace or muffle carbon material,
b) producing CO by making the furnace atmosphere mentioned below contact with these carbon material, and
c) always making the furnace atmosphere reductive against zinc in brass, when brass parts are brazed by feeding these parts continuously into the tunnel type continuous brazing furnace, whose atmosphere is inert nitrogen gas, at relatively low temperature of 630-700° C.

2. A method of copper brazing as in claim 1, and further comprising adding hydrogen up to 10 volume percent to the furnace atmosphere.

3. A method of copper brazing as in claim 1, wherein a copper solder used is a phosphorous bronze type.
